(19) United States
(12) Patent Application Publication
(10) Pub. No.: US 2022/0170957 A1
(43) Pub. Date: Jun. 2, 2022

(54) Magnetic Belt and Magnetic Sensing Device

(71) Applicant: Tyco Electronics (Shanghai) Co. Ltd., Shanghai (CN)

(72) Inventors: Aaron Fan, Shanghai (CN); Marco Colombo, Shanghai (CN)

(73) Assignee: Tyco Electronics (Shanghai) Co. Ltd., Shanghai (CN)

(21) Appl. No.: 17/539,970

(22) Filed: Dec. 1, 2021

(30) Foreign Application Priority Data
Dec. 2, 2020 (CN) 202022850874.X

(51) Int. Cl. G01P 3/48

(52) U.S. Cl. CPC G01P 3/48

(57) ABSTRACT

A magnetic belt used in magnetic sensing device for measuring a rotation speed of a rotating shaft comprises a belt body adapted to be wound around a perimeter of the shaft in the shape of a circle and fixed thereto. The belt body includes a row of toothed protrusions arranged on a first outer surface of the belt body. With the belt body arranged on the shaft, the toothed protrusions are evenly spaced around a circumference of the rotation shaft.

### CROSS-REFERENCE TO RELATED APPLICATIONS

This application claims the benefit of Chinese Patent Application No. 202022850874.X filed on Dec. 2, 2020 in the State Intellectual Property Office of China, the whole disclosure of which is incorporated herein by reference.

### FIELD OF THE INVENTION

The present invention relates to a magnetic belt and a magnetic sensing device including the magnetic belt.

### BACKGROUND

In the prior art, a magnetic sensing device for measuring the rotational speed of a shaft typically includes a gear and a Hall speed sensor. More specifically, the gear is installed on the rotating shaft (e.g., fastened to an end of the shaft), and the Hall speed sensor is arranged proximate the gear. By sensing the changes of the peak and valley of the gear, a corresponding high and low level signal is output and a rotation speed of the gear and the shaft can be measured.

These arrangements, however, are not without significant drawbacks. For example, the gears used in these assemblies are typically precision parts machined from ferrous materials, which may be difficult to accurately install onto the rotating shaft. In this way, the assemblies are very costly to manufacture. Further, driving the gears to rotate requires significant input energy, and the gears typically take up significant space in often space-constrained applications.

Accordingly, improved solutions are desired.

### SUMMARY

According to an embodiment of the present disclosure, a magnetic belt used in magnetic sensing device for measuring a rotation speed of a rotating shaft comprises a belt body adapted to be wound around a perimeter of the shaft in the shape of a circle and fixed thereto. The belt body includes a row of evenly spaced toothed protrusions arranged on a first outer surface of the belt body. With the belt body arranged on the shaft, the toothed protrusions are evenly spaced around a circumference of the shaft.

### BRIEF DESCRIPTION OF THE DRAWINGS

The invention will now be described by way of example with reference to the accompanying Figures, of which:

FIG. 1 is an illustrative perspective view of a magnetic sensing device according to an exemplary embodiment of the present disclosure;

FIG. 2 shows a plan view of a magnetic sensing device according to an exemplary embodiment of the present disclosure;

FIG. 3 is an illustrative view of the magnetic belt in the magnetic sensing device shown in FIG. 1 and FIG. 2; and

FIG. 4 is an illustrative view of an end connecting device of a magnetic belt according to an exemplary embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a magnetic belt used in a magnetic sensing device for measuring a rotation speed of a rotation shaft is provided. The magnetic belt comprises a belt body having one surface on which a row of toothed protrusions evenly spaced and arranged along a length direction of the belt body is formed. The belt body is adapted to be wound in a circle on the rotation shaft and fixed thereto. When the belt body is wound and fixed on the rotation shaft, the toothed protrusions are located on the outside of the magnetic belt and evenly spaced around the circumference of the rotation shaft.

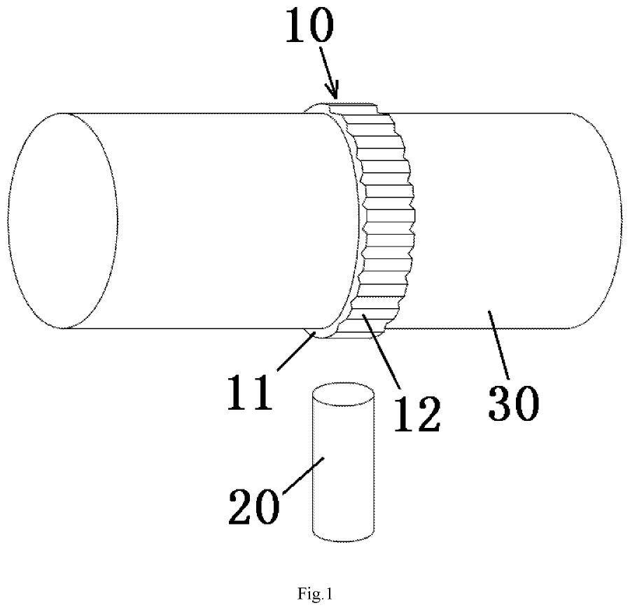

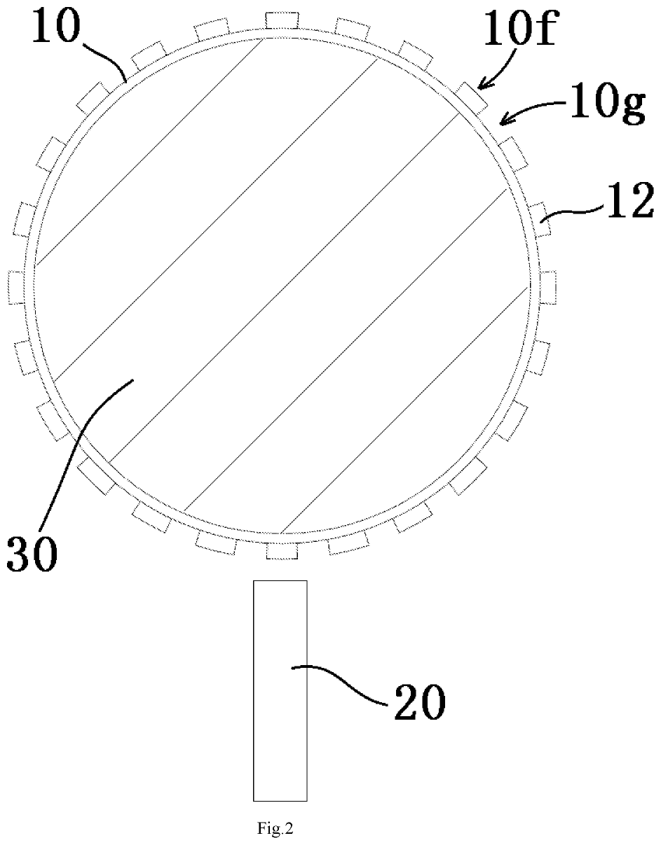

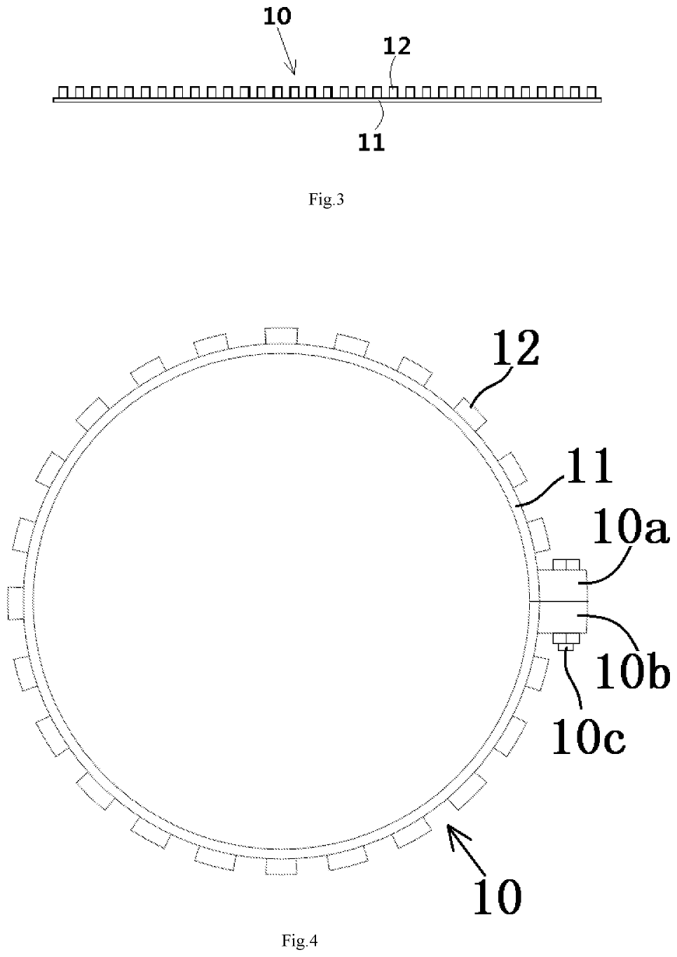

FIG. 1 is an illustrative perspective view of a magnetic sensing device according to an exemplary embodiment of the present disclosure. FIG. 2 is a plan view of a magnetic sensing device according to an exemplary embodiment of the present disclosure. FIG. 3 is an illustrative view of the magnetic belt in the magnetic sensing device shown in FIG. 1 and FIG. 2. As shown in FIGS. 1-3, in an embodiment, a magnetic belt 10 is used in a magnetic sensing device for measuring a rotation speed of a rotation shaft 30. The magnetic belt 10 comprises a belt body 11. A row of toothed protrusions 12 evenly spaced and arranged along a length direction of the belt body 11 is formed on one surface of the belt body 11. The belt body 11 is adapted to be wound on the rotation shaft 30 in a circle and fixed on the rotation shaft 30. When the belt body 11 is wound and fixed on the rotation shaft 30, the toothed protrusions 12 are located on the outside of the magnetic belt 10 and evenly spaced around the circumference of the rotation shaft 30. In an exemplary embodiment, the magnetic belt 10 may be a seamless annular belt or an annular belt with both ends connected together.

FIG. 4 is an illustrative view of an end connecting device of a magnetic belt according to an exemplary embodiment of the present disclosure. As shown in FIGS. 1-4, in an embodiment, the magnetic belt 10 further comprises an end connecting device 10a, 10b, 10c. The end connecting device 10a, 10b, 10c is provided on two ends of the belt body 11 and used to connect the two ends of the belt body. In an embodiment, the end connecting device 10a, 10b, 10c mainly comprises two first connection pieces 10a, two second connection pieces 10b and two bolts or screws 10c. The two first connection pieces 10a are respectively fixed on two sides of one end of the belt body 11. The two second connection pieces 10b are respectively fixed on two sides of the other end of the belt body 11. The two bolts 10c are used to connect the two first connection pieces 10a to the two second connection pieces 10b respectively.

As shown in FIG. 4, in an embodiment the first connection pieces 10a and the second connection pieces 10b are located only on one lateral side of the belt body, or only on two lateral sides of the belt body, wherein a central portion of the belt body does not include connection pieces. Therefore, the continuity of the toothed protrusions 12 on the belt body 11 in a circumferential direction at least in this central portion is not affected.

As shown in FIGS. 1-4, in an embodiment, the first connection piece 10a and the second connection piece 10b are welded to the two ends of the belt body 11 respectively. In an embodiment, a first threaded hole is formed in the first connection piece 10a, a second threaded hole is formed in the second connection piece 10b, and the bolt 10c is screwed into the first threaded hole and the second threaded hole to connect the first connection piece 10a and the second connection piece 10b. In another embodiment, one of the holes comprises an unthreaded through hole, and the other opposing hole comprises a threaded hole.

The belt body 11 is a stamping forming part formed by stamping a flat magnetic material belt (e.g., a trip of ferrous or metallic material), so that the toothed protrusions 12 on the belt body 11 are toothed stamping protrusions. In this way, it may greatly reduce the cost of the magnetic belt 10. In other embodiment, the belt may be an elastic belt formed of an elastic material (e.g., rubber) having ferrous or magnetic elements or materials embedded therein. In one embodiment, a length of the belt body 11 of the magnetic belt 10 is equal to the circumference of the rotation shaft 30, so that the belt body 11 of the magnetic belt 10 is just wound on the rotation shaft 30 in the shape of a circle.

As shown in FIGS. 1-4, a magnetic sensing device is provided for measuring a rotation speed of a rotation shaft 30. The magnetic sensing device comprises the above-described magnetic belt 10 and a magnetic induction sensor 20 (e.g., a Hall effect or Hall speed sensor). The magnetic belt 10 is wound and fixed on the rotation shaft 30. The magnetic induction sensor 20 is arranged proximate (e.g., directly adjacent) the magnetic belt 10 and facing the magnetic belt 10. The magnetic induction sensor 20 is adapted to sense a tooth peak 10f formed by the toothed protrusion 12 and a tooth valley 10g formed by a gap between the toothed protrusions 12 on the magnetic belt 10, and output a high and low level signal corresponding to the tooth peak 10f and the tooth valley 10g. In one embodiment, each tooth peak 10f is defined by a planar end face of the toothed protrusion 12.

As shown in FIGS. 1-4, in an embodiment, the magnetic sensing device may further comprise a rotation speed calculating device. The rotating speed calculating device may be integrated into (i.e., arranged within the illustrated housing of) the magnetic induction sensor 20. The rotation speed calculating device is adapted to calculate the rotation speed of the rotation shaft 30 according to the following formula,

$$n = 60 * F / m , \qquad ( 1 )$$

in which

n is the rotation speed of the rotation shaft 30, the unit of which is rpm,

F is the frequency of the level signal output by the magnetic induction sensor 20, the unit of which is Hz, and

m is the number of the toothed protrusions 12 on the magnetic belt 10.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A magnetic belt used in magnetic sensing device for measuring a rotation speed of a rotating shaft, comprising:
a belt body adapted to be wound around a perimeter of the shaft in the shape of a circle and fixed thereto; and
a row toothed protrusions arranged on a first outer surface of the belt body, with the belt body arranged on the shaft, the toothed protrusions are evenly spaced around a circumference of the shaft.

2. The magnetic belt according to claim 1, further comprising an end connecting device provided on two ends of the belt body for connecting the two ends of the belt body.

3. The magnetic belt according to claim 1, wherein the end connecting device comprises:
two first connection pieces respectively fixed on two lateral sides of one end of the belt body;
two second connection pieces respectively fixed on two lateral sides of the other end of the belt body; and
two bolts used to connect the two first connection pieces to the two second connection pieces respectively.

4. The magnetic belt according to claim 3, wherein the first connection piece and the second connection piece are respectively welded to both ends of the belt body.

5. The magnetic belt according to claim 3, wherein a first threaded hole is formed in the first connection piece, a second threaded hole is formed in the second connection piece, and the bolt is screwed into the first threaded hole and the second threaded hole to connect the first connection piece and the second connection piece.

6. The magnetic belt according to claim 1, wherein the belt body is a stamping forming part formed by stamping a flat magnetic material belt, the toothed protrusions on the belt body defining toothed stamping protrusions.

7. The magnetic belt according to claim 6, wherein the magnetic belt is formed from a monolithic ferromagnetic material.

8. The magnetic belt according to claim 1, wherein the magnetic belt is formed from an elastic material and a ferromagnetic material embedded within the elastic material.

9. The magnetic belt according to claim 1, wherein a length of the belt body of the magnetic belt is equal to a circumference of the shaft.

10. The magnetic belt according to claim 1, wherein the toothed protrusions extend in a direction parallel to a rotational axis of the shaft.

11. A magnetic sensing device for measuring a rotation speed of a rotating shaft, comprising:
a magnetic belt, including:
a belt body adapted to be wound around a perimeter of the shaft in the shape of a circle and fixed thereto; and
a row of evenly spaced toothed protrusions arranged on a first outer surface of the belt body, with the belt body arranged on the shaft, the toothed protrusions are evenly spaced around a circumference of the shaft; and
a magnetic induction sensor arranged proximate the magnetic belt and facing the magnetic belt for sensing a tooth peak formed by the toothed protrusion and a tooth valley formed by a gap between the toothed protrusions on the magnetic belt, the magnetic induction sensor outputting a high and low level signal corresponding to the tooth peak and the tooth valley.

12. The magnetic sensing device according to claim 11, further comprising:
a rotation speed calculating device adapted to calculate the rotation speed of the rotation shaft according to the following formula:
n=60*F/m, in which
n is the rotation speed of the shaft, in rotations per minute (rpm),
F is the frequency of the level signal output by the magnetic induction sensor, in Hertz (Hz), and
m is the number of the toothed protrusions on the magnetic belt.

13. The magnetic sensing device according to claim 11, wherein the magnetic induction sensor is a Hall sensor.

14. The magnetic sensing device according to claim 11, further comprising an end connecting device provided on two ends of the belt body for connecting the two ends of the belt body.

15. The magnetic sensing device according to claim 14, wherein the end connecting device comprises:
two first connection pieces respectively fixed on two sides of one end of the belt body;
two second connection pieces respectively fixed on two sides of the other end of the belt body; and
two bolts used to connect the two first connection pieces to the two second connection pieces respectively.

16. The magnetic sensing device according to claim 15, wherein a center section of the belt body defined between the two first connection pieces and the two second connection pieces in a circumferential direction of the belt body defines a continuous and uninterrupted section of evenly spaced toothed protrusions.

17. The magnetic sensing device according to claim 15, wherein the first connection piece and the second connection piece are respectively welded to both ends of the belt body.

18. The magnetic sensing device according to claim 15, wherein a first through hole is formed in the first connection piece, a second threaded hole is formed in the second connection piece, and the bolt is screwed into the first through hole and the second threaded hole to connect the first connection piece and the second connection piece.

19. The magnetic sensing device according to claim 15, wherein a first threaded hole is formed in the first connection piece, a second threaded hole is formed in the second connection piece, and the screw is screwed into the first threaded hole and the second threaded hole to connect the first connection piece and the second connection piece.

20. The magnetic sensing device according to claim 11, wherein the belt body is a stamped part formed by stamping a flat magnetic material belt, the toothed protrusions on the belt body defining toothed stamping protrusions.
